(19) United States
(12) Patent Application Publication
(10) Pub. No.: US 2010/0296425 A1
(43) Pub. Date: Nov. 25, 2010

(54) METHOD AND SYSTEM FOR ESTABLISHING A CONNECTION WITH A PACKET-BASED APPLICATION SERVER

(76) Inventors: Jonathan Allan Arsenault, Orleans (CA); Eric John Wolf, Stittsville (CA); David William Clark, Carp (CA); Sebastien Groulx, Gatineau (CA); Matthew Sean Rose, Nepean (CA); Nathan Gerald Archer, Russell (CA); Yannick Lessard, Gatinean (CA)

Correspondence Address: SMART & BIGGAR, 1000 DE LA GAUCHETIERE ST. W., SUITE 3300, MONTREAL, QC, H3B 4W5, CA

(21) Appl. No.: 12/809,407

(22) PCT Filed: Dec. 21, 2007
(86) PCT No.: PCT/CA2007/002346

§ 371 Date: Jun. 18, 2010

(51) Int. Cl. H04B 7/00; H04L 12/66

(52) U.S. Cl. 370/310; 370/352

(57) ABSTRACT

A method that comprises receiving over a network connection a signal from a communication device indicative of an intention to initiate a telephony action, and causing a communication link between the communication device and a packet-based application server to be established. The communication link enabling the packet-based application server to receive from the communication device information related to an intended telephony action.

### FIELD OF THE INVENTION

The present invention relates generally to the field of packet-based application servers, and specifically to a method and system for enabling PSTN and wireless communication devices to establish a communication link with a packet-based application server.

### BACKGROUND

Soft switches and other software-based call-routing switches are known in the VoIP world for processing VoIP calls. Many users enjoy using VoIP technology, since the software-based switches that are used to process VoIP calls are able to provide more flexibility and functionality to the processing of calls than more traditional hardware-based switches.

Thus, there is a need in the industry to provide a technological solution that allows the functionality and flexibility of software-based switches to be better utilized by traditional communication devices, such as wireless and PSTN communication devices.

### SUMMARY OF THE INVENTION

In accordance with a first broad aspect, the present invention provides a method that comprises receiving over a network connection a signal from a communication device indicative of an intention to initiate a telephony action, and upon receipt of the signal, causing a communication link between the communication device and a packet-based application server to be established. Once the communication link has been established, the packet-based application server is able to receive from the communication device information related to an intended telephony action, for example communication destination information.

In accordance with a second broad aspect, the present invention provides a network entity comprising a first component suitable for receiving over a network connection a signal from a communication device indicative of an intention to initiate a telephony action and a second component for establishing a communication link between the communication device and a packet-based application server. Once the communication link is established, the packet-based application server can receive from the communication device information related to an intended telephony action, for example communication destination information.

In accordance with a third broad aspect, the present invention provides a method that comprises detecting an intention to initiate a telephony action from a communication device, and issuing a request for a destination of a packet-based application server that is suitable for processing an intended call from the communication device. Upon receipt of the destination of a packet-based application server in response to the request, the method further comprises establishing a communication link with the packet-based application server such that the packet-based application server can receive from the communication device information related to an intended telephony action, for example communication destination information.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 shows a communication network comprising a packet-based application server for processing telephony actions made from different communication devices in accordance with a non-limiting embodiment of the present invention;

FIG. 2 shows a method for establishing a communication link between a packet-based application server and a communication device in accordance with a first non-limiting embodiment of the present invention;

FIG. 3 shows a functional block diagram of a network entity in accordance with a non-limiting embodiment of the present invention;

FIG. 4 shows an expanded flow chart of a method for establishing a communication link between a communication device and a packet-based application server, in accordance with a non-limiting embodiment of the present invention;

FIG. 5 shows three non-limiting representations of the manner in which a communication link can be established between a communication device and a packet-based application server in accordance with a non-limiting embodiment of the present invention; and

FIG. 6 shows a method for establishing a communication link between a packet-based application server and a communication device in accordance with a second non-limiting embodiment of the present invention.

It is to be expressly understood that the description and drawings are only for the purpose of illustration of certain embodiments of the invention and are an aid for understanding. They are not intended to be a definition of the limits of the invention.

### DETAILED DESCRIPTION OF NON-LIMITING EMBODIMENTS

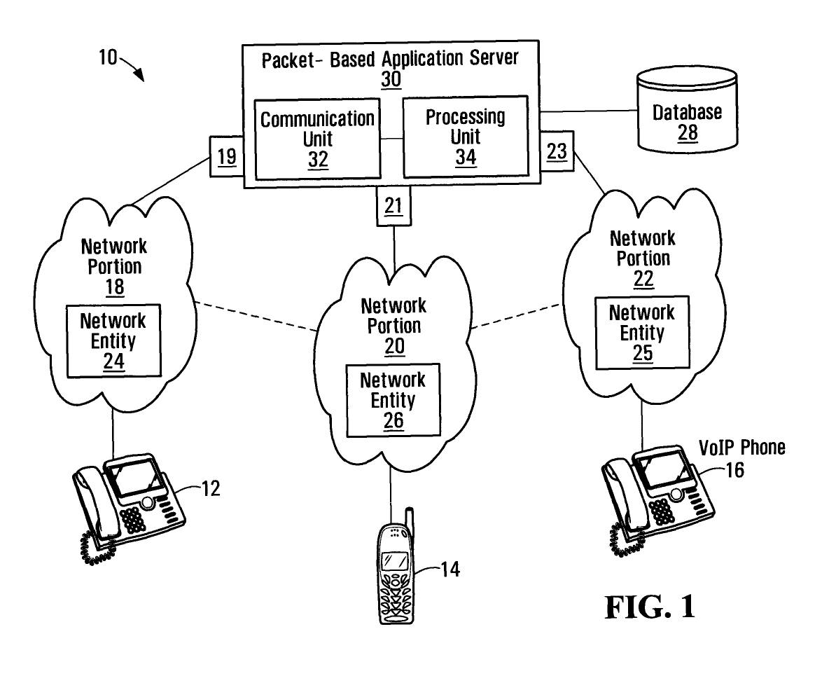

Shown in FIG. 1 is a non-limiting example of a communication architecture 10 that is suitable for enabling communication between different communication devices. The communication architecture 10 includes network portions 18, 20 and 22 that enable the handling of incoming communications, outgoing communications and communications in progress for communication devices 12, 14 and 16. The communication architecture 10 also includes a packet-based application server 30, such that in accordance with the present invention, communications originating from the communication devices 12, 14 and 16 can be routed to a called party or another appropriate destination either by equipment in one or more of the network portions 18, 20 and 22, or in certain circumstances, by the packet-based application server 30. Routing and processing calls via the packet-based application server 30 allows increased flexibility and functionality to be applied to the handling of communications originating from, destined for or ongoing at the communication devices 12, 14 and 16, as well as certain other telephony actions, such as checking voice mail.

The network portions 18, 20 and 22 shown in FIG. 1 may comprise a portion of one or more of a Public Switched Telephone Network (PSTN), a wireless network (e.g., a cellular network), and a data network (e.g., the Internet). In the example shown, network portion 18 comprises a portion of a Public Switched Telephone Network (PSTN) and is responsible for handling communications originating from, and destined for, POTS (Plain Old Telephony System) communication devices, such as POTS communication device 12. The network portion 18 can include a PSTN line, and PSTN equipment for switching and routing calls. For example, network entity 24 can be a DMS switch, among other possibilities.

Network portion 20 comprises a portion of a wireless network (e.g., a cellular network) that is responsible for handling communications originating from, and destined for, wireless communication devices, such as the wireless communication device 14. The wireless communication device 14 can be a cellular phone, a smart-phone or any other mobile communication device, including a telephony-enabled personal digital assistant (PDA), known in the art. The network portion 20 may include a wireless link in combination with a base station and a network-side wireline link, as well as wireless equipment suitable for routing wireless communications, such as network entity 26. The network entity 26 can be a mobile switching center, among other possibilities.

Finally, network portion 22 is a data network, such as the Internet or a digital communications link (e.g., a digital subscriber line (DSL) link or a coaxial cable) that is responsible for handling communications originating from, and destined for, VoIP communication devices, such as VoIP communication device 16. The VoIP communication device 16 can be a dedicated VoIP phone, a POTS phone equipped with an analog terminal adapter (ATA) or a soft phone (i.e., a computer equipped with telephony software), among other possibilities. In certain circumstances, network portion 22 may not require a network entity having switching/routing functionality, since in the case of VoIP communication devices, the switching/routing functionality may be performed directly by the packet-based application server 30. However, in alternative circumstances, the network portion includes a network entity 25 that is suitable for routing communications to/from VoIP communication devices. In such circumstances, the network entity 25 could be a softswitch and the packet-based application server 30 could be a different softswitch, or a dedicated server for performing the functionality that will be described in more detail herein. For example, the network entity 25 can be the MCS 5200 Soft Switch manufactured by Nortel Networks Limited of 8200 Dixie Road, Brampton, Ontario L6T 5P6, Canada, although it should be appreciated that this is but one non-limiting example among many possibilities within the scope of the present invention.

In a further alternative, in the case where a communication device, such as communication device 12 includes both PSTN and IP capabilities (such as a broadband phone), the communication device could be connected to more than one network portion. For example, in such a case, communication device 12 could be connected to both network portion 18 and network portion 22.

It should be appreciated that the PSTN network 18, the wireless network 20 and the data network 22 can be operated and managed by different service providers or alternatively can be managed by the same service provider. As mentioned above, the network portions 18, 20 and 22 enable the communication devices 12 14 and 16 to reach, or be reached by, any of various other communication devices (which are not shown for the sake of simplicity).

More specifically, although FIG. 1 shows only one POTS communication device 12, one wireless communication device 14 and one VoIP communication device 16, it should be appreciated that the communication architecture 10 is suitable for enabling communication between hundreds of thousands of communication devices, if not more. In addition, each of the network portions 18, 20 and 22 is capable of supporting significantly more communication devices than just the ones shown in FIG. 1.

Although only one packet-based application server 30 is shown in FIG. 1, it will be appreciated that the communication architecture 10 can also include multiple interconnected packet-based applications servers. In such cases, the multiple interconnected packet-based application servers may communicate with one another over physical or wireless links, so as to share information and complete the routing of calls.

As mentioned above, in accordance with the present invention, a communication link can be established between a packet-based application server 30 and POTS communication devices (such as POTS phone 12), wireless communication devices (such as wireless communication device 14) and VoIP communication devices (such as VoIP phone 16). As such, communications that originate from the PSTN communication device 12, the wireless communication device 14 or from the VoIP communication device 16, can be processed and/or routed to the appropriate destination by the packet-based application server 30.

In order for the packet-based application server 30 to be able to communicate with the PSTN, wireless and VoIP communication equipment, the communication architecture 10 includes gateways 19, 21 and 23 between the packet-based application server 30 and the network portions 18, 20 and 22. Gateways 19, 21 and 23 enable communication and interoperability between the different network portions 18, 20 and 22 and the packet-based application server 30. Gateways are known in the art, and as such will not be described in more detail herein.

As shown in the example of FIG. 1, the packet-based application server 30 comprises a communication unit 32 and a processing unit 34. In addition, the packet-based application server 30 is communicatively coupled to a database 28. The packet-based application server 30 is operative to interact with the database 28 in order to effect various telephony processing operations, such as when a communication device originates an outgoing call, receives an incoming call or participates in a call in progress. As mentioned above, having the packet-based application server 30 process and route communications from POTS, wireless and VoIP communication devices provides additional functionality and flexibility that is not possible with the more traditional switching entities. For example, the packet-based application server 30 can enable voice recognition, such that a user of a communication device does not need to physically dial a phone number in order to initiate a call. Instead, the user can simply verbalize the call destination information, which can be detected and recognized by the packet-based application server 30 in order to process the call. In addition, the packet-based application server 30 may include functionality to interrupt a call that is in progress in order to provide certain information to a user of a communication device that is engaged in the active call. The packet-based application server 30 may also facilitate features such as three-way, or multi way, calling, among others.

The packet-based application server 30 comprises suitable hardware, firmware, software, control logic, or a combination thereof for implementing its functionality. In accordance with a specific non-limiting example of implementation, the packet-based application server 30 is a softswitch. For example, the packet-based application server 30 can be the MCS 5200 Soft Switch manufactured by Nortel Networks Limited of 8200 Dixie Road, Brampton, Ontario L6T 5P6, Canada, although it should be appreciated that this is but one non-limiting example among many possibilities within the scope of the present invention.

As mentioned above, although only one packet-based application server 30 is shown in FIG. 1, in reality, each of the network portions 18, 20 and 22 can be in communication with multiple different packet-based application servers 30 either directly or indirectly. As such, a given communication device may not always establish a communication link with the same packet-based application server 30. Instead, a communication device may establish a communication link with a different packet-based application server depending on certain circumstances. For example, in the case of a POTS phone that operates within a fixed geographical location, it is possible that the POTS phone will always establish a communication link with the same packet-based application server 30 when a telephony action is initiated and needs to be processed. Alternatively, it's also possible that if the usual packet-based application server is handling a large call volume at a particular time then the POTS phone may establish a communication link with a different packet-based application server that is handling less call load. In yet a further alternative, a different packet-based application server may be used for its ability to deliver the feature or call treatment required. In a non-limiting embodiment, not all packet based application servers may offer the same processing features, or be able to service all of the subscribers to a given service. For example, some packet based application servers might only service certain subscribers or be able to perform certain functionalities.

In the case of a wireless phone that is mobile and that is able to roam to different regions, depending on where the wireless phone is at any given time, a communication link may be established with different packet-based application servers. For example, a communication link may be established with the packet-based application server that is in closest proximity to the phone, with a packet-based application server that is handling the smallest call volume, or with a packet-based application server that can handle a subscriber's telephony features.

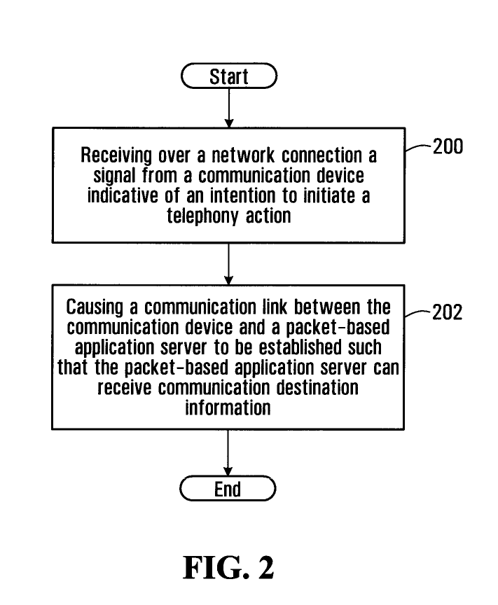

The manner in which a communication link is established between a packet-based application server, such as packet-based application server 30, and a communication device (such as communication device 12 or communication device 14) will now be described in more detail below with respect to the method shown in FIG. 2. As described below in a non-limiting example, the method may be performed by the network entity (either network entity 24, 25 or 26) that is responsible for switching/routing calls within each network portion 18, 20, 22. In the case where a call, or an attempt to initiate another type of telephony action, is being made by a PSTN communication device (such as POTS communication device 12), then it is network entity 24 that will perform the method of causing a communication link to be established between the communication device and the packet-based application server 30. Likewise, in the case where the call, or an attempt to initiate another type of telephony action, is being made by a wireless communication device (such as wireless communication device 14), then it is network entity 26 that will perform this method. In the case where the call, or attempt to initiate another type of telephony action, is being made by a VoIP communication device (such as VoIP communication device 16), then it is network entity 25 that will perform this method.

Firstly, at step 200, the method involves receiving over a network connection a signal from a communication device indicative of an intention to initiate at telephony action. The indication of an intention to initiate a telephony action could be an indication of an intention to place a call, an indication of an intention to send an SMS, IM or other text message, an intention to initiate a video call, or an indication of an intention to check voice mail, among other possibilities. Other telephony actions not mentioned here are also included within the scope of the present invention.

In the case where the signal indicative of an intention to initiate a telephony action is generated by a PSTN communication device, such as POTS communication device 12, the signal is typically received by the network entity 24. As mentioned above, the network entity 24 can be a DMS switch, or any other suitable network equipment for routing calls, or other communications, in a PSTN environment. In the case where the signal indicative of an intention to initiate a telephony action is generated by a wireless communication device, such as wireless communication device 14, the signal is typically received by the network entity 26. The network entity 26 can be a mobile switching center, or any other equipment suitable for routing calls in a wireless environment.

This signal indicative of an intention to initiate a telephony action can be generated in a variety of different ways. For example, in the case of POTS communication device 12, or VoIP communication device 16 the signal can be generated by simply lifting the phone's receiver off the hook, such that the phone goes into an “off hook” condition. Alternatively, the signal may be generated by activating a user-operable input on the communication device, which could be a dedicated feature button on the POTS communication device 12, or a “send button” or other dedicated feature button on the wireless communication device 14. It should be appreciated that the user operable input does not necessarily require a conscious button-press by the subscriber, either. In an alternative embodiment, the user operable input could be triggered based on a predictive behavioral event, such as opening a clamshell phone, or sensing the proximity of the phone to the subscriber's face (such as in the case where a user will issue a voice-command rather than using their dial-pad). In yet another embodiment, the signal indicative of an intention to initiate a telephony action could be generated based on a user providing biometric identification, among other possibilities. The signal indicative of an intention to initiate a telephony action, which typically is indicative of an intention to place a call, is transmitted over a network connection from the communication device to the appropriate network entity. For the sake of simplicity, the indication of an intention to initiate a telephony action is described below as being an intention to place a call.

The signal indicative of an intention to make a call may also provide the network entity with an identification of the communication device that generated the signal. In this manner, the network entity will know which communication device generated the signal indicative of the intention to make a call. The identification of the communication device may be provided by including a unique identifier associated with the communication device. The unique identifier may be a phone number, an electronic serial number (ESN), an IP address or a Uniform Resource Identifier (URI) associated with the communication device, among other possibilities.

At step 202, once the signal has been received at the network entity, the method involves causing a communication link between the communication device and the packet-based application server 30 to be established. As will be described in more detail below, this communication link can be established by directly contacting an appropriate packet-based application server 30 in the case where the destination of the packet-based application server is known, or by issuing a request for the destination of an appropriate packet-based application server 30 and establishing the connection once a response to the request has been received. Each of these scenarios will be described in more detail below.

Once the communication link between the packet-based application server and the communication device is established, the packet-based application server 30 is able to receive communication destination information for the intended call (or information related to a desired telephony action) directly from the communication device. As such, the packet-based application server 30 can receive communication destination information from the communication device. The communication destination information can be a phone number associated with a destination communication device, such that when the calling party wishes to call or send an SMS, IM or other text message to the destination communication device, the phone number can be entered into the calling party's communication device. Alternatively, in the case where a user wants to check his/her voicemail, the communication destination information could be a mailbox number or a password, for example. The call destination information can be provided to the packet-based application server 30 via dialed DTMF tones, dialed wireless CDMA or GSM packets, dialed VoIP packets, or alternatively via voice information entered at the communication device. For example, in the case where the communication destination information is entered via voice information, the user may simply utter phrases such as “call Johnny”, “Voicemail” or the user may recite digits such as“514 777 1234”. The call destination information may also come from a digital source stored on the communication device or retrieved from the network via an address book selection or data based service information exchange.

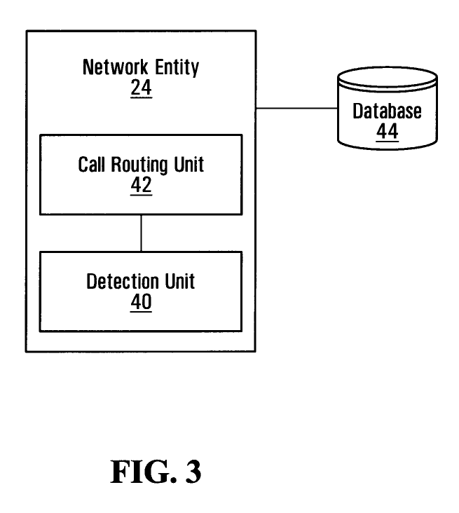

As mentioned above, the method described with respect to FIG. 2 is generally performed by either the network entity 24 (in the case where the intended call is being made by a PSTN communication device), the network entity 26 (in the case where the intended call is being made by a wireless communication device) or the network entity 25 (in the case where the intended call is being made by a VoIP communication device). Shown in FIG. 3 is a non-limiting functional block diagram of a network entity in accordance with the present invention. Although for the purposes of simplicity, FIG. 3 shows network entity 24, it should be appreciated that the network entity shown in FIG. 3 could just as easily be network entity 25 or 26. Anything described herein with respect to network entity 24 is also applicable to network entity 25 or 26.

As shown, network entity 24 includes a detection unit 40 and a call routing unit 42. In addition, the network entity 24 is in communication with a database 44, which may or may not be part of network entity 24. The database 44 may contain call-processing information, among other possible information. The detection unit 40 is operative for receiving the signal indicative of an intention to make a call, or to initiate another telephony action, from a given communication device. Once the detection unit 40 has detected the signal, the call routing unit 42 is operative for routing the intended call through the communication architecture 10. In certain cases, and as will be described below in more detail, the call routing unit 42 is operative for causing a communication link between the packet-based application server 30 and the communication device to be established, such that a call can be processed by the packet-based application server 30.

A call can be routed through the packet-based application server 30 when the communication device is a subscriber to a “packet-based routing feature”. The “packet-based routing feature” enables outgoing calls that are made by the subscribing communication device to be processed and routed through the packet-based application server 30. A list of communication devices and whether or not they subscribe to the “packet-based routing feature” can be stored in the database 44 or, for example, in a presence server that can be queried by the network entity. In an alternative embodiment, the “packet-based routing feature” may be a feature that is offered to all communication devices, regardless of whether they subscribe to this feature. In such a case, a database comprising a list of subscribers to the packet-based routing feature is not necessary.

It should be appreciated that the network entity 24 (as well as network entities 25 and 26) comprises suitable hardware, firmware, software, control logic, or a combination thereof for implementing its functionality, including the functionality of the detection unit 40 and the call routing unit 42. In some embodiments, the network entity 24 (or the network entities 25 and 26), the database 28, and the one or more packet-based application servers 30 may reside in a common network element of the communication architecture 10. In such embodiments, links between these components may be physical (i.e., wired or wireless) links or logical links. In other embodiments, different ones of the network entity 24 (or the network entities 25 and 26), the database 28, and the one or more packet-based application servers 30 may reside in different or common network elements of the communications architecture 10 that are interconnected via one or more physical links and possibly other elements (e.g., gateways) of the communications architecture 10. Also, although it is depicted in FIG. 3 as being one component, the database 44 may be distributed in nature, i.e., it can have portions of its content stored in different memory units possibly located in different network elements of the communications architecture 10. For example, call processing information may be stored in a memory unit dedicated to storing this information and distinct from a memory unit that stores information relating to call feature subscriber information.

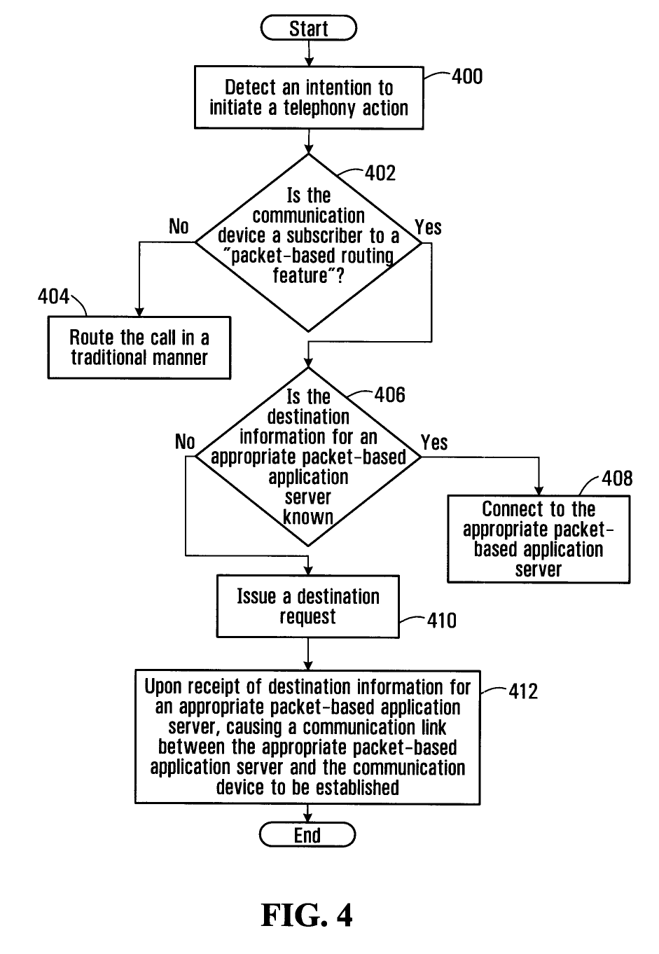

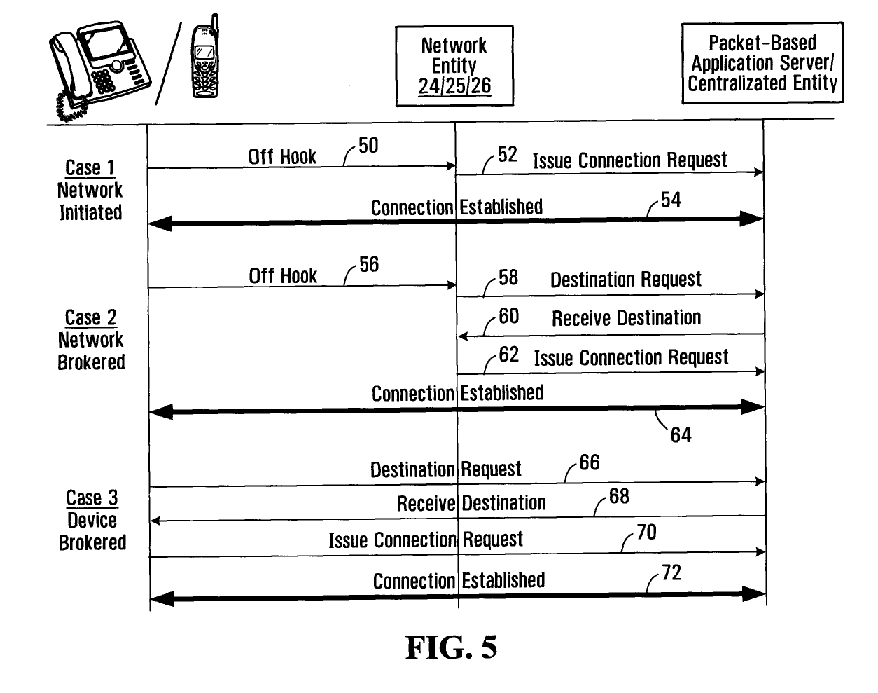

A more detailed explanation of the method of FIG. 2 will now be explained with respect to the flow chart of FIG. 4 and the representative diagram of FIG. 5. It should be appreciated that the process shown in FIG. 4 is performed by the network entity 24 in the case where the intended call is being made by a POTS phone, by the network entity 26 in the case where the intended call is being made by a wireless phone and by network entity 25 in the case where the intended call is being made by a VoIP phone 16. As such, each step of this process will first be described generally, and then with respect to each of network entity 24, 25 and 26 since the details surrounding each step of this process will be different depending on whether the step is being performed by network entity 24 in a PSTN environment, network entity 26 in a wireless environment or network entity 25 in a VoIP environment.

Firstly, at step 400, the network entity detects an intention to make a call from a communication device. This detection occurs at the detection unit 40 of the network entity.

In the case of network entity 24 or 25, this detection occurs upon receipt of a signal from a POTS phone or VoIP phone indicative of an intention to make a call. As described above, this signal may be sent to the network entity 24 (or 25) when the phone receiver is lifted, such that the phone goes “off hook”. Alternatively, the signal may be sent to the network entity 24 (or 25) in response to the actuation of a user actuated input, such as a feature button being pressed.

In the case of network entity 26, this detection may occur upon receipt of a signal from a wireless phone indicative of an intention to make a call. Given that wireless phones do not go “off hook” in the traditional manner, the signal may be sent to the network entity 26 when the user presses the “send/talk” button, opens a clamshell, places the phone close to his/her face, or when a specific feature button is activated. In the case of wireless phones, the signal indicative of an intention to make a call generally requires some form of user involvement, although this is not necessary.

Once a signal indicative of an intention to make a call is received at the detection unit 40 of the network entity, the call routing unit 42 of the network entity proceeds to step 402. The process performed at step 402 is the same regardless of whether it is performed by network entity 24, network entity 25 or network entity 26. During step 402, the call routing unit 42 determines whether the communication device from which the signal was received is a subscriber to the “packet-based routing feature”. As mentioned above, the signal indicative of the intention to make a call includes a unique identifier associated with the communication device that generated the signal. As such, in order to determine whether the communication device is a subscriber to the “packet-based routing feature”, the network entity (either network entity 24 or 26) accesses the database 44 which includes a record of all the communication devices that have subscribed to the “packet-based routing feature”. This may be done by comparing the unique identifier of the communication device received with the signal against a list of communication devices contained within the database that are identified as being subscribers to the packet-based routing feature.

In the case where the network entity determines that the communication device that generated the signal indicative of an intention to make a call is not a subscriber to the “packet-based routing feature”, then the call routing unit 42 will proceed to step 404 wherein the call is processed in a traditional manner. In the case where a communication device includes a dedicated “packet-based feature button” but the user does not subscribe to the “packet-based routing feature”, if a user accidentally presses this button, the user could be presented with a message similar to “Sorry but you are not subscribed” or “sorry, please contact us to enable this feature”, among various other possibilities.

In the case of network entity 24 that operates in the PSTN environment, a call that originates from a POTS communication device that is not a subscriber to the “packet-based routing feature” will be routed by the DMS switch in a traditional manner. More specifically, the DMS switch may use traditional switching equipment in order to route the call to another POTS communication device. Alternatively, the routing of the call may be done across multiple different network environments depending on the type (and, in some cases location) of the communication device to which the call is destined. For example, in the case where the POTS communication device 12 is calling wireless communication device 14, the call will be routed through a gateway into the wireless network, such that the mobile switching center (network entity 26) can complete the routing to the wireless communication device 14.

In the case of network entity 26 that operates in a wireless environment, a call that originates from a wireless communication device that is not a subscriber to the “packet based routing feature” will be routed by the mobile switching center in the traditional manner. More specifically, the mobile switching center may use traditional switching equipment in order to route the call to another wireless communication device. Alternatively, the routing of the call may be done across multiple different network environments depending on the type (and, in some cases location) of the communication device to which the call is destined. For example, in the case where the wireless communication device 14 is calling POTS communication device 12, the call will be routed through a gateway into the PSTN network, such that the DMS switch (network entity 24) can complete the routing to the POTS communication device 12.

As such, in the case where a communication device is not a subscriber to the “packet-based routing feature”, the calls originating from that communication device will be routed using traditional switching functionality, and without using the packet-based application server 30. This routing between networks is illustrated by dashed lines in FIG. 1.

However, in the case where the network entity (either network entity 24, 25 or 26) determines at step 402 that the communication device that issued the signal indicative of an intention to make a call is a subscriber to the “packet-based routing feature”, then the call routing unit 42 of the network entity will proceed to step 406.

It should be appreciated that in the case where the “packet-based routing feature” is provided to all communication devices, and not just to those that subscribe to this feature, then steps 402 and 404 can be removed from the process, and the method would jump directly from step 400 to step 406.

It will be appreciated that there are multiple ways for a given network entity to establish a communication link with a packet-based application server. In a first case, the network entity knows the destination of the packet-based application server to which the communication device should be connected, prior to receiving a signal from a communication device indicative of an intention to make a call. In other words, the network entity knows which packet-based application server to contact in order to establish a communication link, and knows how to contact that packet-based application server.

In a second case, when the network entity receives the signal indicative of an intention to make a call, it is not aware of the destination of an appropriate packet-based application server with which a communication link with the communication device can be established. As such, in this second case, the network entity performs a brokering procedure, wherein the network entity issues a request for the destination of an appropriate packet-based application server upon receipt of a signal indicative of an intention to make a call from a communication device. As used herein, the term “brokering procedure” refers to the process of issuing a request for the destination of an appropriate packet-based server with which the communication device can establish a communication link, and only establishing the link upon receipt of the destination from an external entity. In an alternative embodiment that will not be described in detail herein, instead of the brokering procedure being performed by one of the network entities, it may be performed by alternative hardware and/or software contained within the network portions 18, 20 and 22.

In light of these two situations, namely the situation where the destination of an appropriate packet-based application server is known, and the situation where the destination needs to be determined, at step 406, the call routing unit 42 of the network entity (either network entity 24, 25 or 26) determines whether the destination of an appropriate packet-based application server is known. This can be determined, for instance, by accessing information stored within the database 44.

For example, the database 44 may include destination information associated with one or more appropriate packet-based application servers to which a communications link for a given communication device can be established. The database 44 may also include information indicative of which packet-based application server to use in a given situation. For example, it may be desirable to connect to different packet-based application servers at different times of the day, or on different days of the week. In addition, the database 44 may include a table specifying which packet-based application server is suitable for which communication device. This determination may be based upon geography, telephony features available or subscribed to, or service provider, among other possibilities.

In the case where the database does not include destination information associated with one or more appropriate packet-based application servers, then the database may include program instructions for performing the brokering procedure. The program instructions may include the destination of a local packet-based application server, a a centralized or other network entity to which a destination request signal can be sent. This will be described in more detail below.

In the case where the destination information of a packet-based application server is known prior to receipt of the signal from a communication device indicative of an intention to make a call, the network-entity will proceed to step 408. For the sake of example, let us assume that the known packet-based application server is packet-based application server 30 shown in FIG. 1. At step 408, the network entity contacts the packet-based application server 30 at the known destination so as to establish a communication link between the packet-based application server and the communication device. This scenario is illustrated as “case 1” in FIG. 5.

The destination information of the packet-based application server 30 may be a telephone number or an IP address, among other possibilities. As such, once the signal indicative of an intention to make a call is received at the network entity (as illustrated by line 50 in FIG. 5), the network entity issues a connection request to the packet-based application server 30 (as illustrated by line 52). The connection request may be made, for example, by dialing the telephone number associated with the packet-based application server 30 and providing information to the packet-based application server 30 that may be needed in order to establish the communication link. For example, the connection request 50 may include information such as the identifier of the communication device with which a communication link should be established, and an identifier of the network entity, among other possible information. Upon receipt of the connection request at the packet-based application server 30, a communication link is established between the packet-based application server 30 and the communication device (shown by line 54). This communication link may be established by a handshaking procedure that takes place between the packet-based application server 30 and the communication device, or between the packet-based application server 30, the network entity and the communication device. Once the communication link is established, the packet-based application server 30 can receive call destination information for the intended call from the communication device so as to be able to process the intended call.

Steps 406 and 408 can be performed by the network entities 24, 25 and 26. For example, network entity 24 may know the destination of packet-based application server 30 so as to be able to cause a communication link to be established between PSTN communication device 12 and packet-based application server 30. Likewise, network entity 26 may also know the destination of packet-based application server 30 so as to be able to cause a communication link to be established between wireless communication device 14 and the packet-based application server 30.

Although step 408 which involves contacting the packet-based application server 30 at a destination that is known prior to receiving a signal indicative of an intention to make a call can be performed in both the PSTN and wireless environment, it will be appreciated that step 408 may particularly be common in the PSTN environment. In a PSTN environment, the PSTN communication equipment, such as POTS communication device 12, generally remain within a limited geographical area. As such, the closest packet-based application server 30 to the POTS communication device 12 generally will not change. As such, it makes sense that the POTS communication device could always connect to the same packet-based application server 30. In such a circumstance the local network entity 24, which could be a DMS switch, would already know the destination information for the packet-based application server 30, which could be stored in database 44, for example. With reference to FIG. 5, it should be appreciated that the receipt of the signal indicative of an intention to make a call (line 50) and the issuing of the connection request (line 52) can be done almost instantaneously by the network entity such that establishment of a communication link between the communication device and the packet-based application server is transparent to the user. As such, a user of the communication device is generally unaware of the process that is being performed to establish the communication link with the packet-based application server 30. From the user's perspective, as soon as the user picks up the phone, or activates the “feature” button associated with the “packet-based routing feature”, the communication device is connected to the packet-based application server.

Referring back to FIG. 4, at step 406, when the destination of an appropriate packet-based application server with which a communication link can be established is not known prior to receipt of the signal from the communication device indicative of an intention to make a call, the network entity will proceed to step 410, wherein it begins the brokering procedure. As mentioned above, during the brokering procedure, the network entity issues a request for the destination of an appropriate packet-based application server. This brokering procedure can be performed by either network entity 24, network entity 25 or network entity 26 depending on whether the communication device that issues the signal indicative of an intention to make a call is a POTS communication device, a VoIP communication device or a wireless communication device.

At step 410, the network entity (24, 25 or 26) issues a destination request for a packet-based application server that is operative for processing the intended call from the communication device. This scenario is illustrated as “case 2” in FIG. 5.

As mentioned above, although only one packet-based application server 30 is shown in FIG. 1, the communication architecture 10 can include multiple interconnected packet-based applications servers. The multiple packet-based application servers are each able to communicate with each other, so as to share information and complete the routing of calls. Links between these packet-based application servers may be physical links (i.e., wired or wireless) or logical links.

As such, upon receipt of the signal indicative of an intention to make a call (line 56 in FIG. 5) the network entity sends a destination request (line 58) to either the local packet-based application server 30, or to a centralized or other network entity (which will be described in more detail below). The destination request can be issued by sending a signal-based query message (such as a subscribe/notify or AIN query) to the local packet-based application server, or to the centralized or other network entity.

The destination request that is issued by the network entity may include, for example, information such as the unique identifier of the communication device that would like to make a call, the geographical location of that communication device and the service provider of the communication device. Regardless of what entity (whether the local packet-based application server 30 or a centralized or other network entity) receives the destination request, that entity is able to determine an appropriate packet-based application server for handling the intended call. This determination can be made on the basis of the destination request and the information contained therein, as well as on other factors that are known to the entity that is making the determination. For example, the determination may be made based on the geographical location of the communication device that intends to make a call, such that a communication link is established with a packet-based application server that is in closest proximity to the communication device. The determination may also be made on the basis of the call volume being handled by each of the packet-based application servers in the communication architecture 10, such that a communication link is established with a packet-based application server that is handling a low volume of calls at the given time. In accordance with a further example, the determination may be made on the basis of the service provider of the communication device that intends to make the call, or on the basis of the processing features and services subscribed to by the user of the communication device. In the case where the determination is made by the local packet-based application server 30 (or another packet-based application server having the same structure as packet-based application server 30) the information required to make the determination of an appropriate packet-based application server may, for example, be stored in the database 28 shown in FIG. 1.

For example, database 28 may include information indicative of the geographical location of each of the packet-based application servers 30 in the communication architecture 10, and/or information indicative of the types of subscriber features/services that can be facilitated by given packet-based application servers. The database 28 may also be continually updated, such that it includes information regarding the call volume being handled by each of the packet-based application servers in the communication architecture 10.

Although it is depicted as being one component in the example of FIG. 1, the database 28 may be distributed in nature, i.e., it can have portions of its content stored in different memory units possibly located in different network elements of the communications architecture 10. For example, the call processing information may be stored in a memory unit dedicated to storing this information and distinct from a memory unit that stores information required for determining an appropriate packet-based application server in response to a destination request. In addition, each packet-based application server in the communication architecture 10 may include a separate database 28, or they may each refer to the same database 28 for accessing the information for facilitating the determination of an appropriate packet-based application server.

Once a determination of an appropriate packet-based application server has been made, the destination information for that packet-based application server is then returned to the network entity (line 60 shown in FIG. 5), such that the network entity can contact that packet-based application server at the received destination in order to cause a to communication link between the communication device and the appropriate packet-based application server be established.

To better illustrate this brokering procedure, let us take, for example, the case where the wireless communication device 14 generates a signal indicative of an intention to make a call. As shown in FIG. 1, that signal will be received by network entity 26, which can be, for example, a mobile switching center contained within the wireless network portion 20. Given that the wireless communication device 14 is mobile and can move around, it may not make sense for a communication link to always be established with the same packet-based application server. More specifically, in the case where the wireless phone 14 has traveled a far distance from its home territory, it may make sense for a different packet-based application server to handle a call (or another attempted telephony action) originating from the wireless communication device 14. As such, in the case where the wireless communication device 14 is a subscriber to the “packet-based routing feature”, upon receipt at the network entity 26 of a signal from the wireless phone 14 indicative of an intention to make a call (or attempt another telephony action), the network entity 26 determines that it does not know the destination of an appropriate packet-based application server to service the wireless device 14, and as such issues a destination request.

In accordance with a first example of implementation, the network entity 26 may send the destination request to the wireless communication device 14's local (or home territory) packet-based application server 30. This can be done by issuing a signal-based query to a local packet-based application server 30 via a SIP, AIN or IP address. Upon receipt of the destination request, the local packet-based application server 30 will determine an appropriate packet-based application server with which the wireless phone 14 can establish a communication link. As mentioned above, this determination may be made based on the current geographical location of the wireless communication device 14, the services provided by a given packet-based application server, the features subscribed to by the wireless device and the call load being handled at each of the packet-based application servers in the communication architecture 10. For example, the local packet-based application server 30 may provide the destination of the packet-based application server that is in closest proximity to the wireless communication device 14, or alternatively, may provide the destination of the packet-based application server that is currently handling the least amount of calls from other communication devices. It should be appreciated that other criteria for determining an appropriate packet-based application server are also within the scope of the present invention. For example, an appropriate packet-based application server may be determined on the basis of the service provider of the wireless communication device 14.

In accordance with a second example of implementation, the network entity 26 may send the destination request to a centralized entity. The centralized entity may be one or a plurality of other packet-based application servers. Alternatively, the centralized entity may be a dedicated request handling entity that is operative to field destination requests from hundreds of thousands of other communication devices, and designate an appropriate packet-based application server for each destination request. The centralized entity can be contacted via a signal-based query. As such, no matter where the wireless communication device is located, it will not be complicated to contact the centralized entity. In the case where the centralized entity is a plurality of packet-based application servers, the signal-based destination request query can be simultaneously sent to towards all of the packet-based application servers via an intermediate load-balancer/load-sharing element which will decide which individual packet-based application server to which to send the destination request.

Upon receipt of the destination request, the centralized entity will determine an appropriate packet-based application server with which the wireless communication device 14 can establish a communication link. This determination may be made based on the geographical location of the wireless communication device 14 and the call-load capacity at each of the packet-based application servers in the communication architecture 10, among other possibilities.

Although the above example has been illustrated with respect to wireless communication device 14, step 410 could also have been described with an example in the PSTN and VoIP environments.

Regardless of whether the destination request is handled by a local packet-based application server 30, or a centralized entity, once the determination of an appropriate packet-based application server has been made, the destination information associated with the appropriate packet-based application server is sent to the network entity 26 (this is illustrated by line 60 in FIG. 5). Therefore, at step 412, upon receipt of the destination of an appropriate packet-based application server, the network entity issues a connection request to the appropriate packet-based application server (as illustrated by line 62). The issued connection request is made by contacting the appropriate packet-based application server at the destination provided in response to the destination request. This may be done by dialing a telephone number indicated in the received destination information. The connection request may also include any information needed by the appropriate packet-based application server to establish the communication link with the communication device. For example, the connection request may include information such as the identifier of the communication device and/or the identifier of the network entity, among other possible information.

Upon receipt of the connection request at the appropriate packet-based application server, a communication link is established between the appropriate packet-based application server and the communication device (line 64 of FIG. 5) such that the packet-based application server can receive communication destination information (or information related to a desired telephony action) from the communication device. This communication link may be established by a handshaking procedure that takes place between the packet-based application server and the communication device, or between the packet-based application server, the network entity and the communication device.

As previously mentioned, the brokering process described above with respect to steps 410 and 412 in FIG. 4 can be performed by the network entity 24, the network entity 25 or the network entity 26 depending on the type of communication device that has indicated an intention to made a call. The brokering procedure involves a sequence of signals being sent back and forth between the network entity and either the local packet-based application server 30 or a centralized entity, in order to receive an indication of an appropriate packet based application server with which a communication device can establish a communication link.

With reference to FIG. 5, it should be appreciated that the brokering process described above and shown with respect to lines 58, 60 is performed almost instantaneously. As such, a user of the communication device is generally unaware of the brokering process that is being performed to establish the communication link with an appropriate packet-based application server. From the user's perspective, as soon as the user picks up the phone, or activates a “feature” button associated with the “packet-based routing feature”, the communication device is connected to the packet-based application server.

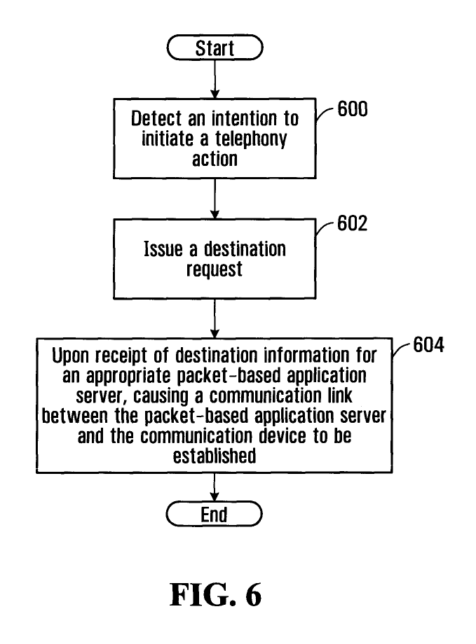

In an alternative embodiment, instead of the brokering process being performed by a network entity, the brokering process can be performed directly by the communication device itself. This will now be described in more detail with respect to the flow chart shown in FIG. 6, and “case 3” illustrated in FIG. 5. For the purposes of simplicity, the process shown in FIG. 6 will be described with respect to the wireless communication device 14. However, it should be appreciated that a similar process could also be described with respect to PSTN communication devices, such as POTS communication device 12, and VoIP communication devices.

In the case where the brokering procedure is performed by the wireless communication device 14, at step 600, the wireless communication device 14 detects an intention to initiate a telephony action which, for the purposes of example only, will be described herein as an intention to make a call. The detection of the intention to make a call can be detected by an application resident on the communication device. Furthermore, in the case where the brokering procedure is performed by the communication device, the communication device must have some internal processing capabilities as well as a data connection (i.e. IP, CDMA, GSM, EDGE, EVDO, WiMax, WiFi etc). For example, the communication device may be any one of a wireless communications device, POTS phone with an IP connection, VoIP phone or computer equipped with a VoIP soft client.

The detection of the intention to make a call by the application resident on the communication device may be based on a variety of factors. For example, in the case of wireless communication device 14, the detection can take place when a feature button or the “send/talk button” is activated, when a clamshell is opened, or a specific application can be launched, among other possibilities. In the case of a VoIP or broadband phone, the intention to make a call can be detected when the phone receiver is lifted off the hook, or when a specific feature button is pressed. In this case, the application may monitor for detection of the off-hook condition. In other cases, launching of the specific application would indicate an intention to make a call.

Once the intention to make a call has been detected by the application resident at the wireless communication device 14, the application issues a destination request (line 66 in FIG. 5). In the same manner as described above, this destination request can be sent to either the local packet-based application server 30 or to a centralized entity, which could be one or a plurality of other packet-based application servers or a request handling entity. The request handling entity may be operative to field destination requests from tens of thousands or hundreds of thousands (if not more) of other communication devices, and designate an appropriate packet-based application server for each request.

In a non-limiting example, upon detection of an intention to make a call (or initiate another telephony action), the application issues a destination request to a network-based application or server (that stores or has access to a database of destination information for packet-based application servers of the type previously described) over the data connection (using a URL or IP address link) for an appropriate packet-based application server to which the present communication device should be connected. In the case of a wireless communication device, issuing of the destination request (via accessing a link provided by a URL or IP address) by the application resident on the communication device may result in an interface being presented to the user for supplying his/her current location so that destination information for an appropriate packet-based application server (based on current location, for example) may be determined. Alternatively, the location of a subscribing wireless communication device may be tracked on a continual basis such that issuance of the destination request (via accessing a link provided by a URL or IP address) by the application results in the wireless communication device being provided with destination information for an appropriate packet-based application server (based on current location, for example) without any user input. In yet a further alternative, the wireless communication device may be updated by a network-based application or server on a regular basis (e.g. at regular time intervals) with destination information of an appropriate packet-based application server to which a communication link should be established. In any case, destination information for an appropriate packet-based application server is determined by the network-based application or server and returned to the communication device via the data connection. It will readily be appreciated that a similar process for retrieving destination information for an appropriate packet-based application server may be followed when the communication device is a VoIP phone, a POTS phone with an IP connection or a computer equipped with a VoIP softclient.

When a wireless phone makes a destination request directly to an application server, the destination request is passed through the mobile switching center, in order to get switch logic to route the destination request to the packet-based application server or the centralized entity. In such circumstances, the mobile switching center operates in a traditional manner.

The destination request that is issued by the application resident on the wireless communication device 14 asks for the destination of an appropriate packet-based application server with which the wireless communication device 14 can establish a communication link. The destination request may include information such as the unique identifier of the wireless communication device 14, the geographical location of the wireless communication device 14 at that time, and the service provider of the wireless communication device 14. Any other information that is suitable for helping the local packet-based application server 30, or the centralized entity, determine an appropriate packet-based application server with which a communication link can be established can also be included in the destination request.

Once the determination of an appropriate packet-based application server has been made, the destination information associated with that appropriate packet-based application server is sent to the wireless communication device 14 (line 68 in FIG. 5). The appropriate packet-based application server may be determined based on a variety of factors, such as its proximity to the wireless communication device 14, the telephony features or services it is able to provide, or based on the call load that is currently being handled. It should be appreciated that a variety of other factors can be used to determine an appropriate packet-based application server with which the wireless communication device 14 can establish a communication link.

At step 604, upon receipt of the destination information of an appropriate packet-based application server, the wireless communication device 14 issues a connection request to the appropriate packet-based application server (as illustrated by line 70 in FIG. 5). This connection request can be passed through the respective network entity (e.g. a mobile switching center). The connection request may be made, for example, by dialing a telephone number indicated in the received destination information or by forwarding a signal-based request. The connection request can also forward to the packet-based application server any information needed to establish the communication link. For example, the connection request may include information such as the unique identifier of the communication device and its current geographical location, among other possible information.

Upon receipt of the connection request at the appropriate packet-based application server, a communication link is established between the packet-based application server and the communication device (line 72 in FIG. 5). This may be achieved via a handshaking procedure between the packet-based application server and the wireless communication device 14 (which could be performed with a network entity as an intermediary). Once the communication link is established, the packet-based application server can receive call destination information (or information related to another telephony action) from the wireless communication device 14. More specifically, using the example cited above, once a communication link has been established, the packet-based application server is able to receive destination information for the intended call from the communication device.

In accordance with the present invention, the destination information for the intended call (or information related to another telephony action) is not entered into the communication device until the communication link with the packet-based application server has been established. In this manner, when the user enters the destination information into the communication device, it is received at the packet-based application server as it is being entered into the communication device.

It will be appreciated that the destination information for an intended call (or information related to another telephony action) may be entered into the communication device by dialing DTMF tones, forwarding CDMA or GSM packets, or by entering voice information. In the case of POTS communication device 12, once the communication link with a packet-based application server has been established, the packet-based application server will “hear” the DTMF tones as they are being dialed into the communication device. For example, in the case of DTMF tone collection, the DTMF tones can be collected via an inband procedure, wherein the DTMF tones are passed through the media path as sounds (both PSTN and cell networks can do this), or the DTMF tones can be collected via an out-of-band procedure, wherein the DTMF tones are sent via non media signals (such as CDMA or GSM packets, SIP messaging, etc. . . . ). In the case of a wireless communication device 14, the packet-based application server will “receive” the CDMA or GSM packets as they are being generated. This may be done by receiving signaling in the network similar to SIP. Finally, in the case where the user enters the call destination information via voice information, which can be done at either the POTS communication device 12, the wireless communication device 14, or the VoIP phone 16, the packet-based application server will “hear” the voice information as it is being entered. In this manner, much of the functionality and flexibility in call handling that is provided by packet-based application servers can be applied to calls made through traditional PSTN and wireless communication equipment.

In the above-described methods of establishing a communication between a communication device and a packet-based application server, it is the client who initiates the start of establishing the connection request. In alternative embodiments that are not described in detail herein, it is possible that the packet based application server could establish and maintain a constant connection with the communication device such that the packet based application server actively listens for a client to provide an indication of an intention to initiate a telephony action. This type of constant monitoring may be established, for example, when a communication device is detected as present on the network.

Those skilled in the art will appreciate that, in some embodiments, certain functionality of a given component described herein (including the network entities 24 and 26 and the packet-based application server 30) may be implemented as pre-programmed hardware or firmware elements (e.g., application specific integrated circuits (ASICs), electrically erasable programmable read-only memories (EEPROMs), etc.) or other related elements. In other embodiments, a given component described herein (including the network entities 24 and 26 and the packet-based application server 30) may comprise a processor having access to a code memory which stores program instructions for operation of the processor to implement functionality of that given component. The program instructions may be stored on a medium which is fixed, tangible, and readable directly by the given component (e.g., removable diskette, CD-ROM, ROM, fixed disk, USB key, etc.). Alternatively, the program instructions may be stored remotely but transmittable to the given component via a modem or other interface device connected to a network over a transmission medium. The transmission medium may be either a tangible medium (e.g., optical or analog communications lines) or a medium implemented using wireless techniques (e.g., microwave, infrared or other wireless transmission schemes).

While specific embodiments of the present invention have been described and illustrated, it will be apparent to those skilled in the art that further modifications and variations can be made without departing from the scope of the invention as defined in the appended claims.

1. A method, comprising:
a) receiving over a network connection a signal from a communication device indicative of an intention to initiate a telephony action;
b) upon receipt of the signal indicative of an intention to initiate a telephony action, causing a communication link between the communication device and a packet-based application server to be established such that the packet-based application server can receive from the communication device information related to an intended telephony action.

2. A method as defined in claim 1, wherein upon establishment of the communication link, the packet-based application server can receive from the communication device, the information related to an intended telephony action as it is being entered at the communication device.

3. A method as defined in claim 1, wherein upon detection of the signal indicative of an intention to initiate a telephony action, establishing the communication link by contacting the packet-based application server at a destination known prior to receipt of the signal indicative of an intention to initiate a telephony action.

4. A method as defined in claim 1, wherein upon receipt of the signal indicative of the intention to initiate a telephony action, said method further comprises:
issuing a request for a destination of a packet-based application server that is operative for processing an intended telephony action from the communication device; and
contacting the packet-based network server at the destination received in response to the request, in order to establish the communication link between the communication device and the packet-based application server.

5. A method as defined in claim 1, wherein the communication device is a PSTN communication device.

6. A method as defined in claim 1, wherein the communication device is a wireless communication device.

7. A method as defined in claim 1, wherein the intention to initiate a telephony action is detected based on a hand receiver being lifted.

8. A method as defined in claim 1, wherein the intention to initiate a telephony action is detected based on an “off hook” signal being received.

9. A method as defined in claim 1, wherein the intention to initiate a telephony action is detected based on the activation of a user-operable input indicative of a desire to connect the communication device to a packet-based application server.

10. A method as defined in claim 1, wherein the packet-based application server is a softswitch.

11. A method as defined in claim 1, wherein the information related to an intended telephony action is received at the packet-based application server in the form of voice information.

12. (canceled)

13. (canceled)

14. (canceled)

15. (canceled)

16. A network entity comprising:
a) a first component suitable for receiving over a network connection a signal from a communication device indicative of an intention to initiate a telephony action;
b) a second component for causing a communication link between the communication device and a packet-based application server to be established such that the packet-based application server can receive from the communication device information related to an intended telephony action.

17. A network entity as defined in claim 16, wherein upon establishment of the communication link, the packet-based application server can receive from the communication device the information related to an intended telephony action as it is being entered at the communication device.

18. A network entity as defined in claim 16, wherein said second component establishes the communication link by contacting the packet-based application server at a destination known prior to receipt of the signal indicative of the intention to initiate a telephony action.

19. A network entity as defined in claim 16, wherein said second component is operative for:
issuing a request for a destination of a packet-based application server that is operative for processing an intended telephony action from the communication device; and
contacting the packet-based network server at the destination received in response to the request, in order to establish the communication link between the communication device and the packet-based application server.

20. A network entity as defined in claim 16, wherein the packet-based application server is a softswitch.

21. A network entity as defined in claim 16, wherein upon establishment of the communication link, the packet-based application server can receive voice information from the communication device as it is being entered at the communication device, the voice information being indicative of information related to an intended telephony action.

22. A network entity as defined in claim 16, wherein said network entity is a DMS switch.

23. A network entity as defined in claim 16, wherein said network entity is a mobile switching center.

24. A network entity as defined in claim 16, wherein said network entity is a softswitch.

25. (canceled)

26. (canceled)

27. (canceled)

28. (canceled)

29. A method, comprising:
a) detecting an intention to initiate a telephony action from a communication device;
b) in response to the intention to initiate a telephony action, issuing a request for a destination of a packet-based application server that is suitable for processing an intended call from the communication device; and
c) upon receipt of the destination of a packet-based application server in response to said request, causing a communication link with the packet-based application server to be established such that the packet-based application server can receive from the communication device information related to an intended telephony action.

30. A method as defined in claim 29, wherein upon establishment of the communication link, the packet-based application server can receive from the communication device the information related to an intended telephony action as it is being entered at the communication device.

31. A method as defined in claim 29, wherein the communication device and the packet-based application server are connected over a packet-based network portion.

32. A method as defined in claim 29, wherein the communication device is one of a PSTN communication device and a wireless communication device.

33. A method as defined in claim 29, wherein the intention to initiate a telephony action is detected based on a hand receiver of the communication device being lifted.

34. A method as defined in claim 29, wherein the intention to initiate a telephony action is detected based on an “off hook” signal being received.

35. A method as defined in claim 29, wherein the intention to initiate a telephony action is detected based on the activation of a user-operable input on the communication device indicative of a desire to connect the communication device to a packet-based application server.

36. A method as defined in claim 29, wherein the packet-based application server is a softswitch.

37. A method as defined in claim 29, wherein the information related to an intended telephony action is received at the packet-based application server in the form of voice information.

38. A method as defined in claim 29, wherein the request for a destination of a packet-based application server is issued over a PSTN environment.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. A communication device suitable for initiating a telephony action, said communication device comprising:
a) a processing unit suitable for generating a request for a destination of a packet-based application server that is suitable for processing an intended call from said communication device;
b) an interface suitable for:
c) issuing said request over a network connection;
d) in response to receipt of a destination of a packet-based application server in response to said request, causing a communication link with a packet-based application server to be established such that the packet-based application server can receive from said communication device information related to an intended telephony action.

57. (canceled)

58. (canceled)

59. (canceled)

60. (canceled)

61. (canceled)

62. (canceled)

63. (canceled)

64. A computer-readable storage medium comprising a program element for execution by a processing unit to implement a network entity, said program element comprising:
first program code for receiving over a network connection a signal from a communication device indicative of an intention to initiate a telephony action;
second program code for causing a communication link between the communication device and a packet-based application server to be established, upon receipt of the signal indicative of an intention to initiate a telephony action, such that the packet-based application server can receive from the communication device information related to an intended telephony action.
